(19) United States
(12) Patent Application Publication
(10) Pub. No.: US 2015/0002972 A1
(43) Pub. Date: Jan. 1, 2015

(54) PROTECTION DEVICE AND POWER SUPPLY DEVICE WITH THE SAME

(71) Applicants: HONG FU JIN PRECISION INDUSTRY (ShenZhen) CO., LTD ., Shenzhen (CN); HON HAI PRECISION INDUSTRY CO., LTD., New Taipei (TW)

(72) Inventors: BO TIAN, Shenzhen (CN); KANG WU, Shenzhen (CN); YU HAN, Shenzhen (CN)

(73) Assignees: HONG FU JIN PRECISION INDUSTRY (ShenZhen) CO., LTD ., Shenzhen (CN); HON HAI PRECISION INDUSTRY CO., LTD., New Taipei (TW)

(21) Appl. No.: 14/252,319

(22) Filed: Apr. 14, 2014

(30) Foreign Application Priority Data
Jun. 27, 2013 (CN) 201310262338X

(51) Int. Cl. H02H 7/20

(52) U.S. Cl. CPC H02H 7/20
USPC 361/91.1

(57) ABSTRACT

Protection device includes a group of lines, a protection board, and a connector. The group of the lines includes a first line and a second line. The first line is a ground wire and the second line is a power wire. The protection board includes a number of protection members. The connector includes a first connector port and a second connector port. The first line is directly connected to the first connector port, and the corresponding second line is connected to the corresponding second connector port through the protection board.

### FIELD

The present disclosure relates to protection devices, and particularly, to a protection device capable of protecting loads electrically coupled to the protection device and a related power supply device.

### BACKGROUND

Usually, load is powered by a power source via a power line or a printed circuit board (PCB). However, the usual PCB may not include the needed protection function, such as an overcurrent protection and an overvoltage protection function, for example. Thus, when the power supplied by the power source to the loads is unsteady, the loads may be damaged.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a power supply device in accordance with an exemplary embodiment.

FIG. 2 is a perspective isometric view of a connection device of the power supply device of FIG. 1.

FIG. 3 is an exploded view of the connection device of FIG. 2.

### DETAILED DESCRIPTION

The embodiments of the present disclosure are now described in detail, with reference to the accompanying drawings. In the following disclosure the term “coupled” is defined as connected, whether directly or indirectly through intervening components, and is not necessarily limited to physical connections. The connection can be such that the objects are permanently connected or releasably connected.

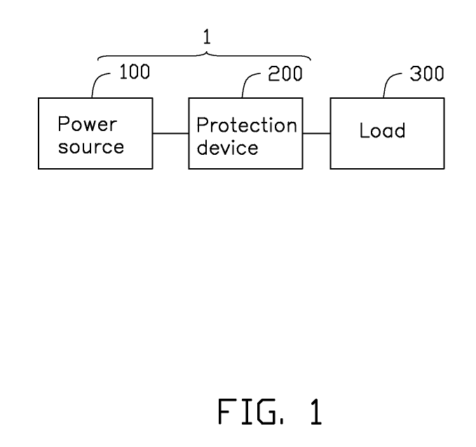

FIG. 1 illustrates an embodiment of a power supply device 1. The power supply device 1 includes at least one power source 100 and a protection device 200. The at least one power source 100 can be electrically coupled to at least one load 300 via the protection device 200 and supplies power to the at least one load 300 via the protection device 200. The protection device 200 includes a number of protection functions, thus the at least one load 300 electrically coupled to the at least one power source 100 is protected by the protection device 200.

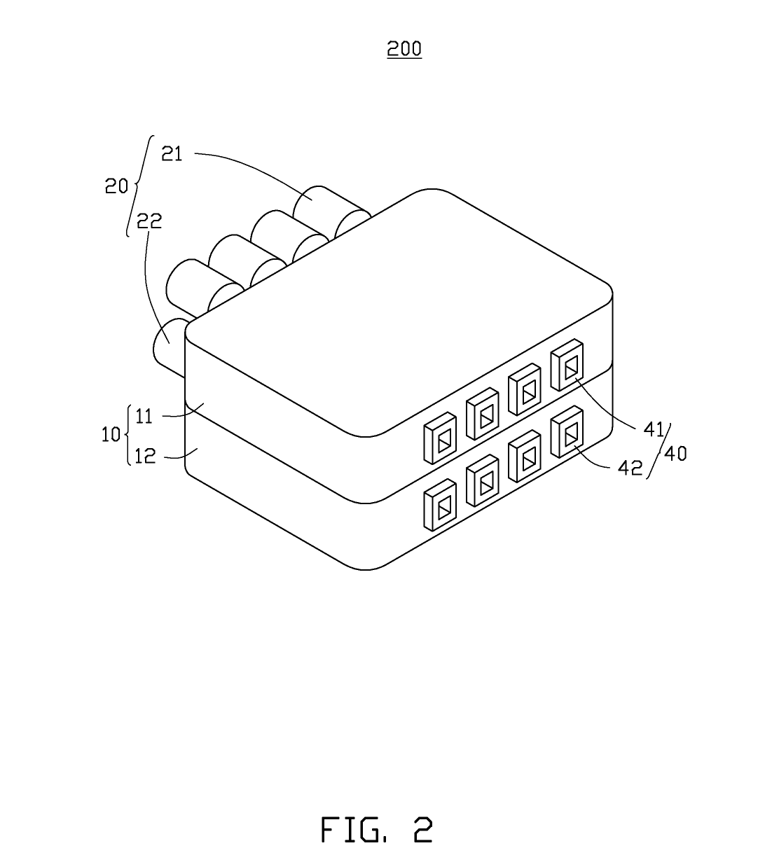

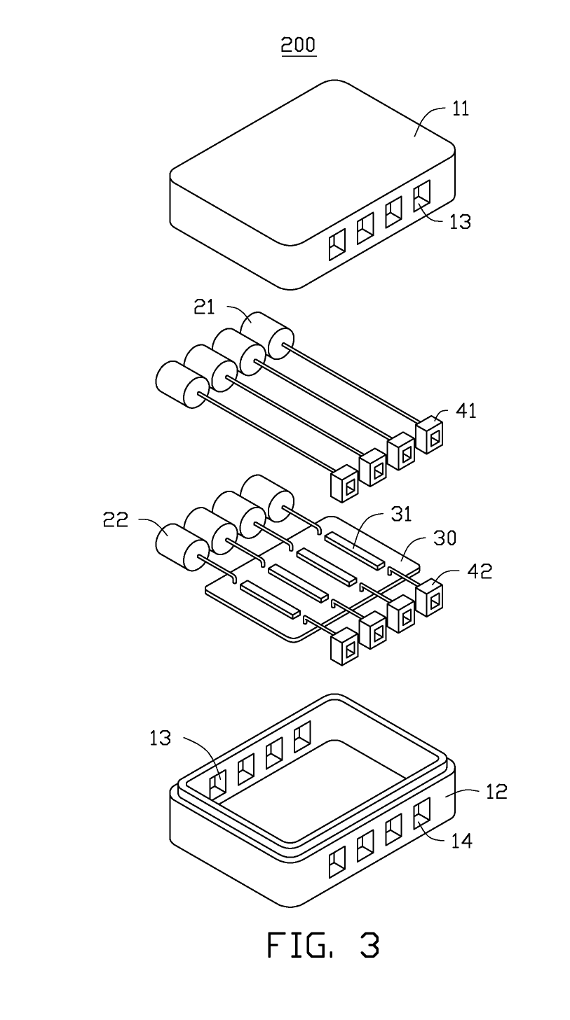

FIGS. 2-3 illustrate that the protection device 200 includes a housing 10, at least one group of lines 20, a protection board 30, and at least one connector 40. The housing 10 includes a first casing 11 and a second casing 12. The first casing 11 covers the second casing 12. The first casing 11 and the second casing 12 cooperatively define a receiving space to receive the at least one group of lines 20, the protection board 30, and the at least one connector 40. A sidewall of the first casing 11 and a sidewall of the second casing 12 respectively define at least one first through hole 13. An opposite sidewall of the first casing 11 and an opposite sidewall of the second casing 12 respectively define at least one second through hole 14. Each first through holes 13 of the first casing 11 respectively corresponds to one of the first through holes 13 of the second casing 12. Similarly, each of the second through holes 14 of the first casing 11 respectively corresponds to one of the second through holes 14 of the second casing 12.

Each of the at least one group of lines 20 are transmitting lines which are coupled to the at least one power source 100 and receive the power of the at least one power source 100. In the embodiment, each of the at least one group of lines 20 includes a first line 21 and a second line 22. Each first line 21 is a ground wire and each second line 22 is a power wire. In the embodiment, each first line 21 passes through one first through hole 13 of the first casing 11, and the corresponding second line 22 passes through the corresponding first through hole 13 of the second casing 12.

In the embodiment, the protection board 30 is a printed circuit board. The protection board 30 includes a number of protection members 31, which can be one or more of: a fuse, an overvoltage protection chip, and an overcurrent protection chip; thus, the protection board 30 has a number of protection functions.

Each of the at least one connectors 40 is a port to be coupled to one load 300. Each of the at least one connector 40 includes a first connector port 41 and a second connector port 42. Each first connector port 41 passes through one second through hole 14 of the first casing 11, and the second connector port 42 passes through the corresponding second through hole 14 of the second casing 12. Thus, each first line 21 is directly connected to one first connector port 41, and the corresponding second line 22 is connected to the corresponding second connector port 42 via the protection board 30.

Further referring back to FIG. 1, in the embodiment, the protection device 200 further includes a number of voltage converters. When only one power source 100 is employed, a voltage supplied by the power source 100 can be converted to different voltages by the voltage converters, thus the power supply device 1 can supply a same or different voltage to the loads 300 through different connectors 40. Of course, when more power sources 100 are employed in the power supply device 1, the voltages supplied by the power supply device 1 to the loads 300 via different connectors 40 can be greater than the voltages supplied by the power supply device 1 to the loads 300 when one power source 100 is employed.

With this configuration, the power of the at least one power source 100 supplies to the at least one load 300 must first pass through the protection members 31, the problem of power overcurrent and overvoltage, is accordingly abated before supplying power to the loads 300, thus the loads 300 are protected.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A protection device comprising:
at least one group of lines, each of the at least one group of the lines comprising a first line and a second line, each first line being a ground wire and each second line being a power wire;
a protection board comprising a plurality of protection members; and
at least one connector, each of the at least one connector comprising a first connector port and a second connector port, each of the first lines being directly connected to one first connector port, and the corresponding second line being connected to the corresponding second connector port through the protection board.

2. The protection device as described in claim 1, wherein the protection board is a printed circuit board.

3. The protection device as described in claim 1, further comprising a housing, wherein the housing comprises a first casing and a second casing, the first casing covers the second casing and cooperatively define a receiving space to receive the at least one group of lines, the protection board, and the at least one connector; a sidewall of the first casing and a sidewall of the second casing respectively define at least one first through hole, and an opposite sidewall of the first casing and an opposite sidewall of the second casing respectively define at least one second through hole; each of the first lines passes through one first through hole of the first casing, and the corresponding second line passes through one first through hole of the second casing; each of the first connector ports passes through one second through hole of the first casing, and the corresponding second connector port passes through one second through hole of the second casing.

4. The protection device as described in claim 1, wherein each protection member is selecting from a group of consisting of a fuse, an overvoltage protection chip, and an overcurrent protection chip.

5. A power supply device comprising:
at least one power source; and
a protection device comprising:
at least one group of lines, each of the at least one group of lines being coupled to the at least one power source, each of the at least one group of lines comprising a first line and a second line, each of the first lines being a ground wire and each of the second lines being a power wire;
a protection board comprising a plurality of protection members; and
at least one connector, each of the at least one connector comprising a first connector port and a second connector port, each of the first lines being directly connected to one first connector port, and the corresponding second lines being connected to the corresponding second connector port through the protection board.

6. The power supply device as described in claim 5, wherein the protection board is a printed circuit board.

7. The power supply device as described in claim 5, further comprising a housing, wherein the housing comprises a first casing and a second casing, the first casing covers the second casing and cooperatively define a receiving space to receive the at least one group of lines, the protection board, and the at least one connector; a sidewall of the first casing and a sidewall of the second casing respectively define at least one first through hole, and an opposite sidewall of the first casing and an opposite sidewall of the second casing respectively define at least one second through hole; each of the first lines passes through one first through hole of the first casing, and the corresponding second line passes through the corresponding first through hole of the second casing; each of the first connector ports passes through one second through hole of the first casing, and the corresponding second connector port passes through the corresponding second through hole of the second casing.

8. The power supply device as described in claim 5, wherein each protection member is selecting from a group of consisting of a fuse, an overvoltage protection chip, and an overcurrent protection chip.

9. The power supply device as described in claim 5, wherein each of the connectors is a port to be coupled one load.
